(19) United States
(12) Patent Application Publication
(10) Pub. No.: US 2008/0271333 A1
(43) Pub. Date: Nov. 6, 2008

(54) BALL LINER FOR GOLF

(76) Inventors: Min-Hsien Sung, Wugu (TW); Chen-Chun Chen, Taipei (TW)

Correspondence Address: HDSL, 4331 STEVENS BATTLE LANE, FAIRFAX, VA, 22033, US

(21) Appl. No.: 11/742,805

(22) Filed: May 1, 2007

(51) Int. Cl. A63B 69/36; G01B 3/14

(52) U.S. Cl. 33/562; 473/268

(57) ABSTRACT

A ball liner having an annular scale, which defines a circular center hole for drawing an endless horizontal line, a first arched scale bridging the annular scale over the circular center hole at a location biased shorter than one half of the length of the annular scale for drawing a club head alignment line, a second arched scale perpendicularly extending from one side of the first arched scale to the annular scale over the circular center hole, and a third arched scale perpendicularly extending from one side of the first arched scale to the annular scale over the circular center hole in direction opposite to the extending direction of the second arched scale, and a longitudinal slot cut through the second arched scale in line with one side of the third arched scale for drawing a directional guideline.

### BACKGROUND OF THE INVENTION

1. Field of the Invention

The present invention relates to a ball liner for marking aiming lines on a golf ball and more particularly, to such a ball liner that allows for marking aiming lines on the surface of a golf ball in multi axis.

2. Description of the Related Art

Playing golf is a kind of charming sports game. Golf is played on an area of land designated as the course. Under the natural green environment in a golf course, people exercise the body. The game of golf brings pleasure and spiritual encouragement. The course consists of a series of holes. A golf ball is first hit from a tee to the green, i.e., the low cut area surrounding the actual hole in the ground of the course. When reached the green, the player must use a putter to put the ball into the hole. Before putting, the player must visually check the putting direction and angle.

Putting a golf ball into a hole is not so easy. It requires practice and skill. Assistant means may be used to help accurate putting. Taiwan patent publication number M272563 discloses a ball line marker. This design of ball line marker comprises a semispherical top cover and a semispherical base. The semispherical top cover is adapted to cover the upper half of the ball, having a plurality of line holes and marking holes. The semispherical top cover has a pivot means at one end and a retaining member at the opposite end. The semispherical base fits the lower half of the ball, having a circular bottom adjustment hole through which a part of the ball protrudes over the outside wall of the semispherical base. The semispherical base also has a pivot means pivoted to the pivot means of the semispherical top cover, and a retaining member for fastening to the retaining member of the semispherical top cover to hold the semispherical top cover in the close position.

The aforesaid ball line maker allows the user to draw aiming lines on the surface of a golf ball. However, before using the ball line maker to draw lines on the ball, the user must adjust the position of the ball in the semispherical base and then close the semispherical top cover so as not to draw a line over the trademark or logo at the ball. Further, this design of ball line makrer cannot help the user draw an endless horizontal line, or multiple lines in different directions at one cycle. Before drawing a nex aiming line, the user must open the semispherical top cover and adjust the position of the ball in the semispherical base. Further, the ball line marker cannot help the user draw connected lines, or an endless line around the periphery of the ball. Although the semispherical base has a circular bottom adjustment hole for the insertion of a finger to rotate the ball and to further adjust the position of the ball in the semispherical base, the use still cannot accurately check the position of the ball through the line or marking holes of the semispherical top cover when rotating the ball in the semispherical base. Therefore, when drawing an aiming line, the aiming line may extend over the trademark or logo of the ball.

### SUMMARY OF THE INVENTION

The present invention has been accomplished under the circumstances in view. It is one object of the present invention to provide a ball liner, which allows the user to draw on the surface of the inserted golf ball multiple lines in different directions including horizontal line, club head alignment line, directional guideline, and etc., and also allows the user to rotate the inserted golf ball, so as not to draw a line over the trademark or logo at the golf ball.

To achieve this and other objects of the present invention, the ball liner comprises an annular scale, the annular scale defining therein a circular center hole; a first arched scale bridging the annular scale over the circular center hole at a location biased shorter than one half of the length of the annular scale; a second arched scale perpendicularly extending from one side of the first arched scale to the annular scale over the circular center hole; and a third arched scale perpendicularly extending from one side of the first arched scale to the annular scale over the circular center hole in direction opposite to the extending direction of the second arched scale.

### BRIEF DESCRIPTION OF THE DRAWINGS

FIG. 1 is an elevational view of a ball liner in accordance with the present invention.

FIG. 2 is a side view of the ball liner in accordance with the present invention.

FIG. 3 is a top view of the ball liner in accordance with the present invention.

FIG. 4 is a schematic drawing showing an application example of the present invention.

FIG. 5 is a top view of FIG. 4.

FIG. 6 corresponds to FIG. 5, showing the golf ball marked with lines according to the present invention.

FIG. 7 is a schematic extended out view of an alternate form of the ball liner according to the present invention.

FIG. 8 corresponds to FIG. 7, showing the ball liner closed.

### DETAILED DESCRIPTION OF THE PREFERRED EMBODIMENT

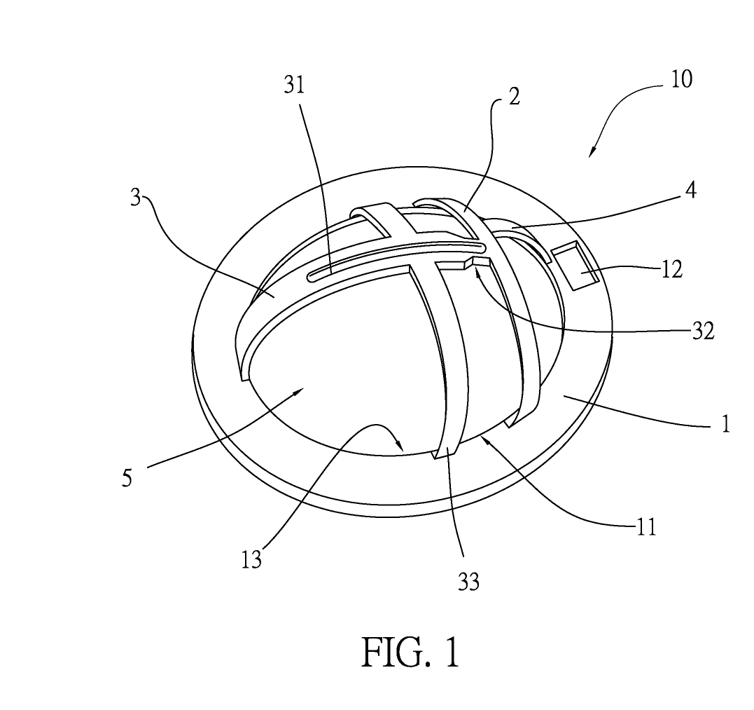

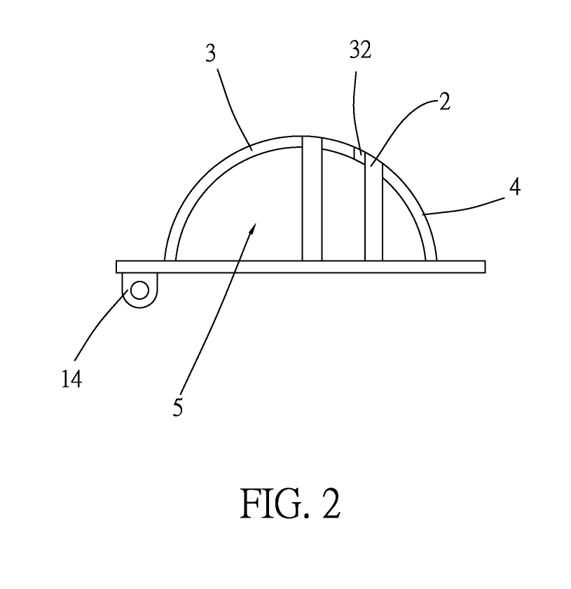

Referring to FIGS. 1 and 2, a ball liner 10 in accordance with the present invention is shown comprising an annular scale 1 defining a circular center hole 11, a first arched scale 2 bridging the annular scale 1 over the circular center hole 1 at a location shorter than one half of the length of the annular scale 1 for drawing an aiming line on a golf ball such that the aiming line is visually biased to one side of the golf ball as the player aims the club head at the golf ball, a second arched scale 3 perpendicularly extending from one side of the first arched scale 2 to the annular scale 1 over the circular center hole 11, a longitudinal slot 31 cut through the second arched scale 3 and extending in direction along the length of the second arched scale 3 for the insertion of a pen to draw a directional guideline on the surface of the golf ball, two notches 32 disposed at two sides of the connection area between the second arched scale 3 and the first arched scale 2 so that the user can draw two axis lines along the second arched scale 3 and the first arched scale 2 toward each other, and an arched reinforcing frame 33 connected between the midpoint of each of two opposite sides of the annular scale 1 and two opposite lateral sides of the second arched scale 3 over the circular center hole 11 to reinforce the structural steadiness of the ball liner 10 and to enhance the sense of beauty. Similar to the function of the first arched scale 2, the arched reinforcing frame 33 can also be used for drawing an axis line on the golf ball. The ball liner 10 further comprises a third arched scale 4 perpendicularly extending from one side of the first arched scale 2 to the annular scale 1 over the circular center hole 11 in direction opposite to the extending direction of the second arched scale 3 such that one side of the third arched scale 4 is in line with the longitudinal slot 31. Therefore, the axis line that is drawn on the ball along the longitudinal slot 31 and the axis line that is drawn on the ball along the third arched scale 4 are longitudinally aligned in line.

Further, along the inside wall 13 of the annular scale 1 around the circular center hole 11, the user can draw a 360° horizontal line on the surface of the golf ball so that when putting the golf ball with a golf putter toward the hole, the player can visually check the horizontal alignment of the horizontal line on the golf ball with the ground of the green and then estimate and adjust the precision of the directional guideline to guide the golf ball putting action.

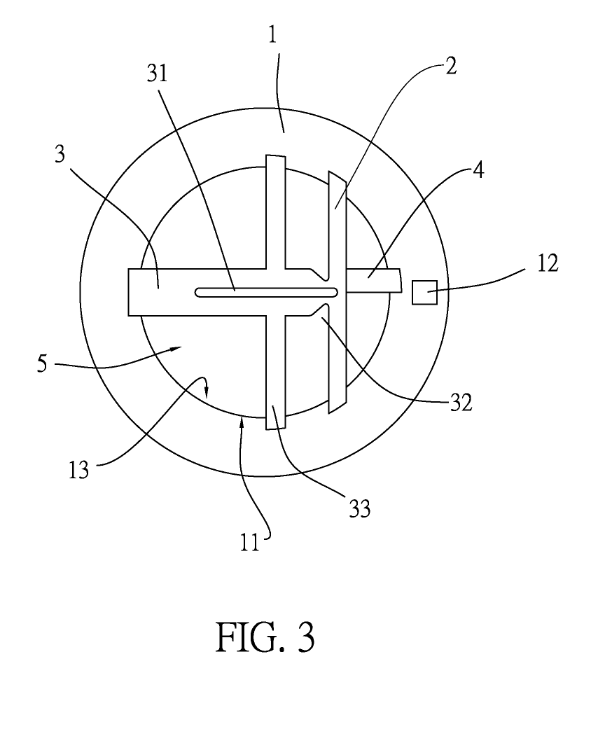

Referring to FIG. 3 and FIGS. 1 and 2 again, the first arched scale 2, the second arched scale 3 and the third arched scale 4 form a semispherical shell on the annular scale 1 around the circular center hole 11, therefore the arched scales 2˜4 define with the annular scale 1 an accommodation open chamber 5 for holding the golf ball to be marked. The user can rotate the golf ball in the accommodation open chamber 5 to adjust the best line-marking position, so as not to draw a line over the trademark or logo at the golf ball.

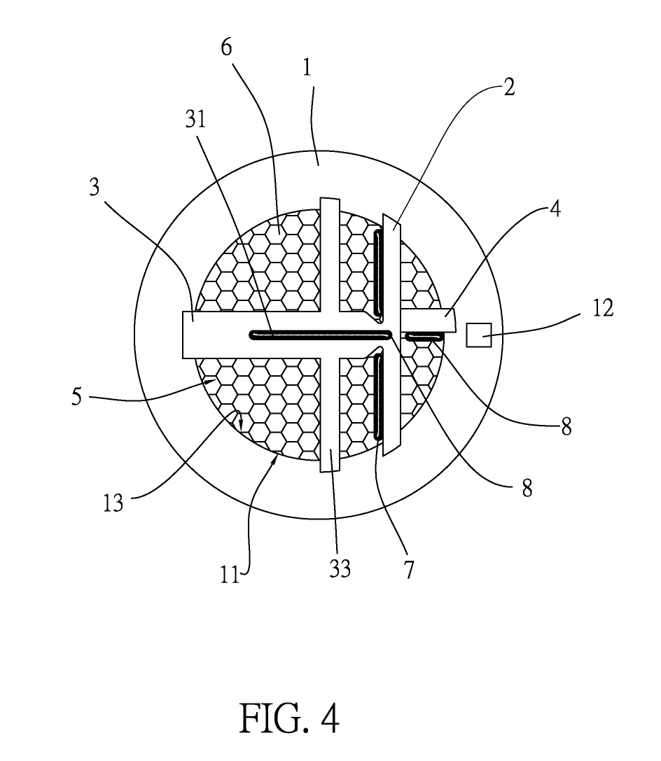

Referring to FIG. 4 again, before putting the golf ball 6 into the hole in the green, the player can cap the ball liner 10 on the golf ball 6 and attach the ball liner 10 to the ground of the green to have about one half of the spherical area of the golf ball 6 be received in the ball liner 10, and then rotate the golf ball 6 is the ball liner 10 to adjust the best line-marking position, keeping the trademark or logo of the golf ball 6 from sight.

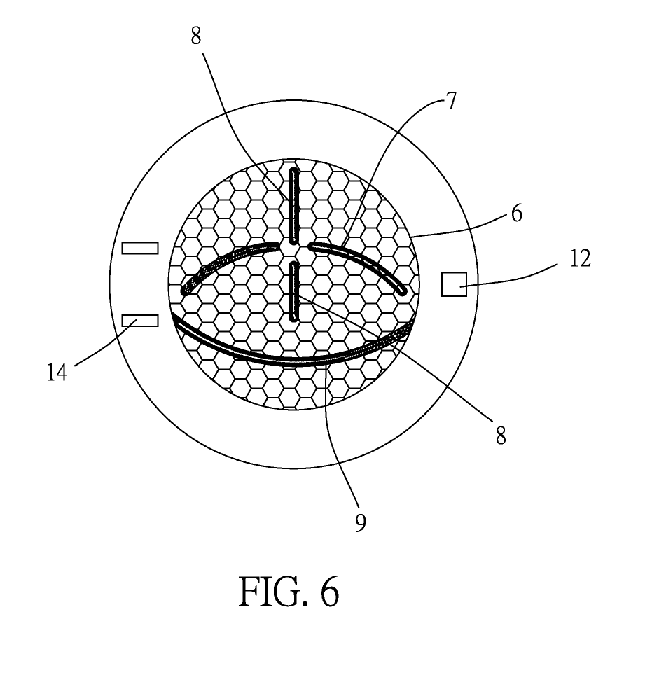

After adjustment of the position of the golf ball 6 in the ball liner 10, the user can move the writing tip of a pen (not shown) along an inner side of the first arched scale 2 to draw a club head alignment line 7 on the golf ball 6 that is visually biased to one side of the golf ball (see FIG. 6). When putting the golf ball 6, the user can visually check whether or not the club head is kept in parallel to the club head alignment line 7. By means of the guidance of the club head alignment line 7, the face of the club head (the head of the putter) can drive the golf ball toward the hole accurately.

Thereafter, the user can move the writing tip of the pen along the longitudinal slot 31 of the second arched scale 3 and one side of the third arched scale 4 to draw a directional guideline 8 on the surface of the golf ball 6 (see FIG. 6) for aiming the golf ball 6 at the hole. By means of the directional guideline 8, the user (player) can see whether the rolling direction of the rolling golf ball is accurate or biased from the accurate direction.

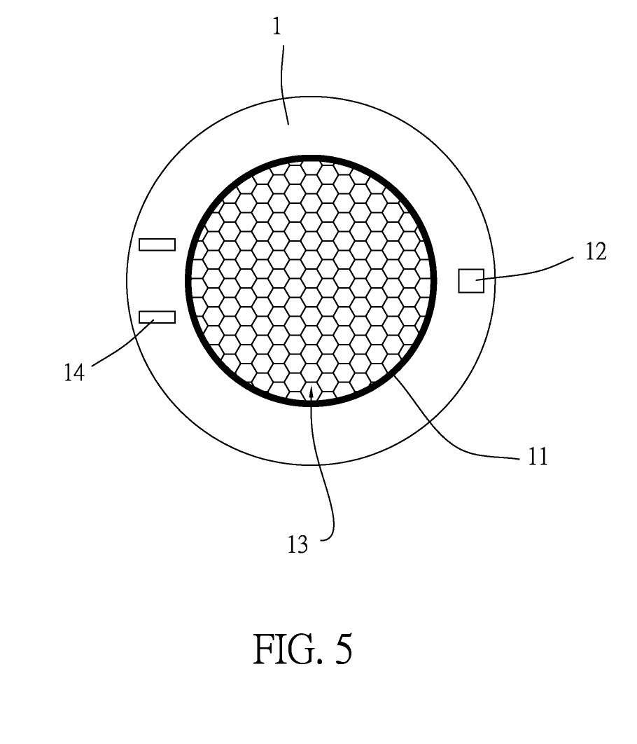

Referring to FIGS. 4 and 5 again, when the golf ball 6 is inserted into the ball liner 10, one half of the golf ball 6 is disposed outside the annular scale 1. By means of the inside wall 13 of the annular scale 1 around the circular center hole 11, the user can draw a 360° horizontal line 9 on the surface of the golf ball 6 (see FIG. 6). Before putting the golf ball 9 with a golf putter, the player can visually check the horizontal alignment of the horizontal line 9 with the ground of the green and then estimate and adjust the precision of the directional guideline to ensure an accurate ball-putting action.

Referring to FIG. 6 again, after desired aiming lines have been drawn on the surface of the golf ball 6 by means of the ball liner 10, the golf ball 6 is put on the ground of the green. At this time, the user can visually check whether the horizontal line 9 on the surface of the golf ball 6 is in parallel with the ground of the green or not. When the horizontal alignment of the horizontal line 9 on the surface of the golf ball 6 with the ground of the green is confirmed, the directional guideline 8 is used to aim the ball at the hole accurately. Before putting the golf ball 6, visually check whether the face of the head of the golf putter is kept in parallel with the club head alignment line 7. When checked OK, the player can then put the golf ball 6 to the hole. When the golf ball 6 is rotating toward the hole in the green, the player can see whether the rotating path of the golf ball 6 is in the accurate way or biased from the way. Therefore, by means of the club head alignment line 7, the directional guideline 8 and the horizontal line 9, the player can visually check and adjust the position of the golf ball and the putting angle.

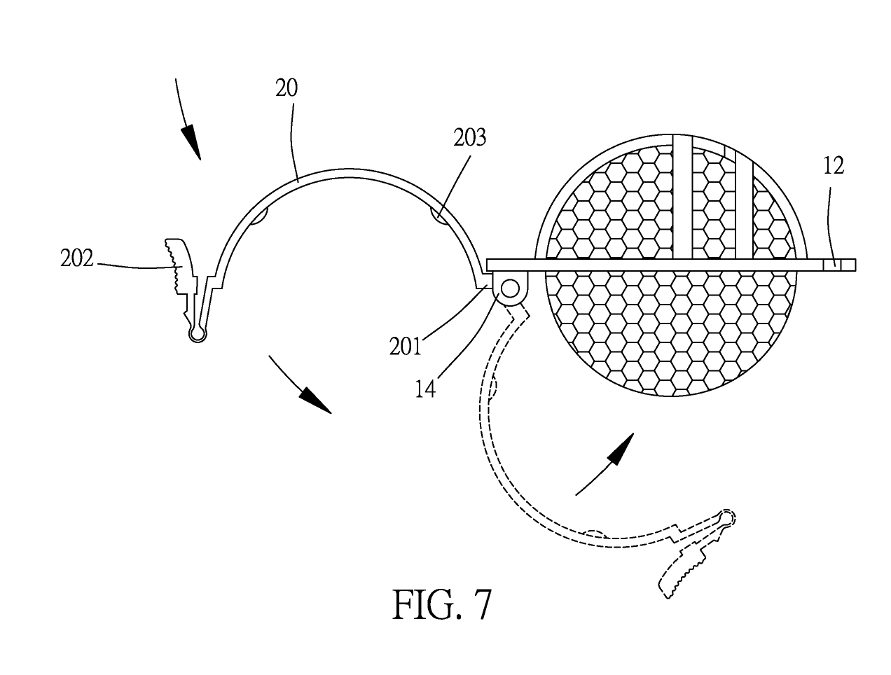

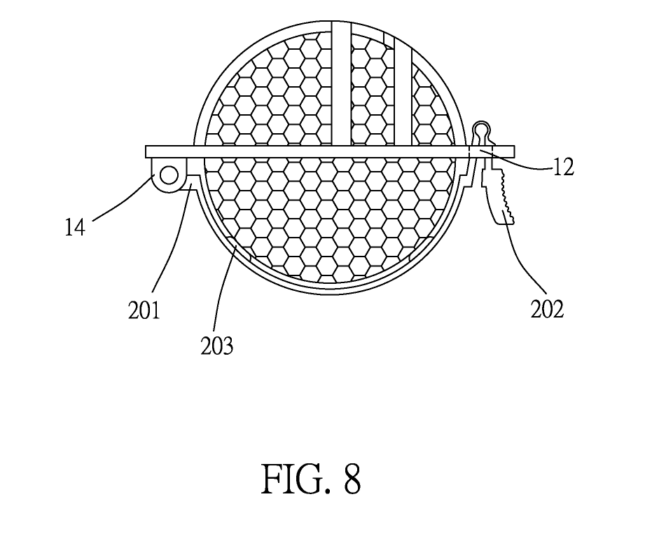

FIGS. 7 and 8 show an alternate form of the present invention. The annular scale 1 has a through hole 12 and a lug 14. This embodiment further comprises a smoothly arched retaining device 20. The smoothly arched retaining device 20 has a pivot 201 disposed at one end and pivoted to the lug 14 of the annular scale 1, and a U-shaped springy retaining portion 202 for engaging into the through hole 12. After the user insert the golf ball 6 into the ball liner, the U-shaped springy retaining portion 202 of the smoothly arched retaining device 20 is engaged into the through hole 12 to close the smoothly arched retaining device 20, holding the golf ball 6 firmly in the ball liner. Further, the smoothly arched retaining device 20 has a plurality of raised portions 203 for friction contact with the surface of the golf ball 6 to hold down the golf ball 6 firmly in the ball liner.

Although particular embodiments of the invention have been described in detail for purposes of illustration, various modifications and enhancements may be made without departing from the spirit and scope of the invention.

What the invention claimed is:

1. A ball liner comprising:
an annular scale, said annular scale defining therein a circular center hole;
a first arched scale bridging said annular scale over said circular center hole at a location biased shorter than one half of the length of said annular scale;
a second arched scale perpendicularly extending from one side of said first arched scale to said annular scale over said circular center hole; and
a third arched scale perpendicularly extending from one side of said first arched scale to said annular scale over said circular center hole in direction opposite to the extending direction of said second arched scale.

2. The ball liner as claimed in claim 1, wherein said annular scale is a rounded annular member.

3. The ball liner as claimed in claim 1, wherein said second arched scale has a longitudinal slot extending along the length thereof for drawing a directional guideline on the surface of a golf ball.

4. The ball liner as claimed in claim 3, wherein said longitudinal slot is in line with one side of said third arched scale.

5. The ball liner as claimed in claim 1, further comprising two notches disposed at two sides of the connection area between said second arched scale and said first arched scale.

6. The ball liner as claimed in claim 1, further comprising an arched reinforcing frame connected between the midpoint of each of two opposite sides of said annular scale and two opposite lateral sides of said second arched scale over said circular center hole.

7. The ball liner as claimed in claim 1, wherein said annular scale has a lug at one side and a through hole at an opposite side.

8. The ball liner as claimed in claim 7, further comprising a retaining device for holding down a golf ball in said circular center hole of said annular scale, said retaining device comprising a pivot disposed at one end thereof and pivoted to said lug of said annular scale and a springy retaining portion for engaging the through hole of said annular scale.

9. The ball liner as claimed in claim 8, wherein said retaining device comprises at least one raised portion protruded from an inner surface thereof
